(19) United States
(12) Patent Application Publication
(10) Pub. No.: US 2005/0288068 A1
(43) Pub. Date: Dec. 29, 2005

(54) Automobile appliance holder with signal receiver

(76) Inventor: Wen-Feng Tsay, Taipei (TW)

Correspondence Address: WEN-FENG TSAY, P. O. Box 24-108, TAIPEI, R. O. C., TW

(21) Appl. No.: 10/873,437

(22) Filed: Jun. 23, 2004

(51) Int. Cl. H04M 1/00

(52) U.S. Cl. 455/569.2; 455/575.9; 455/90.3

(57) ABSTRACT

An automobile appliance holder with signal receiver that connects to the cigarette lighter to form electrical connection, a pair of side clips can fix mobile phones, PDA's, video games, LCD TV's onto the base pedestal; a conversion circuitry offers power, charging and hands-free functions for those mobile appliances, the corresponding connecting pedestal connect these mobile appliances to the base pedestal, by the control and output of the conversion circuitry inside the base pedestal, these mobile appliances can have power, be charged and have hands-free functions. A revolvable receiving pedestal is installed on one side of the base pedestal, a signal receiver is inside the receiving pedestal, the signals are transferred to these mobile appliances directly or through a conversion circuitry; the base pedestal is fixed onto the car cigarette lighter or the arm rack, a wire connects to the car cigarette lighter to form electrical connection for power, charging and hands-free functions; by adjusting the direction of the receiving pedestal for right receiving direction to receive and transmit satellite and video signals.

### BACKGROUND OF THE INVENTION

I. Field of the Invention

This invention relates generally to an automobile appliance holder, more specifically, to an automobile appliance holder with signal receiver that has the automobile holder function and meets the signal receiving quality requirement; the present invention can connect to the cigarette lighter to form electrical connection, the side clips can fix mobile phones, PDA's, video games, LCD TV's onto the base pedestal; a conversion circuitry offers power, charging and hands-free functions for those mobile appliances, the corresponding connecting pedestal connect these mobile appliances to the base pedestal, by the control and output of the conversion circuitry inside the base pedestal, these mobile appliances can have power, be charged and have hands-free functions. A revolvable receiving pedestal is installed on one side of the base pedestal, a signal receiver is inside the receiving pedestal, the signals are transferred to these mobile appliances directly or through a conversion circuitry; the base pedestal is fixed onto the car cigarette lighter or the arm rack, a wire connects to the car cigarette lighter to form electrical connection for power, charging and hands-free functions; by adjusting the direction of the receiving pedestal for right receiving direction to receive and transmit satellite and video signals.

II. Description of the Prior Art

Heretofore, it is known that mobile devices such as mobile phones, PDA's, video games, LCD TV's are more and more popular; if these devices are applied on automobiles, with the metal shield of automobile body and fast moving effect, the transmission signal quality by satellite, TV signals, video signals might suffer. In order to increase the convenience, car antenna is installed externally; however the installation needs professional staff to spend long time, the cost is very high; the external antenna might also affect the overall appearance, increase the maintenance problem, aerodynamic issue; if the direction of antenna is not adjusted to the right direction, the receiving might vary with direction.

### SUMMARY OF THE INVENTION

It is therefore a primary object of the invention to provide an automobile appliance holder with signal receiver that connects to the cigarette lighter to form electrical connection, the side clips can fix mobile phones, PDA's, video games, LCD TV's onto the base pedestal; a conversion circuitry offers power, charging and hands-free functions for those mobile appliances, the corresponding connecting pedestal connect these mobile appliances to the base pedestal, by the control and output of the conversion circuitry inside the base pedestal, these mobile appliances can have power, be charged and have hands-free functions. A revolvable receiving pedestal is installed on one side of the base pedestal, a signal receiver is inside the receiving pedestal, the signals are transferred to these mobile appliances directly or through a conversion circuitry; the base pedestal is fixed onto the car cigarette lighter or the arm rack, a wire connects to the car cigarette lighter to form electrical connection for power, charging and hands-free functions; by adjusting the direction of the receiving pedestal for right receiving direction to receive and transmit satellite and video signals.

### BRIEF DESCRIPTION OF THE DRAWINGS

The accomplishment of the above mentioned object of the present invention will become apparent from the following description and its accompanying drawings which disclose illustrative an embodiment of the present invention, and are as follows:

FIG. 1 is a perspective view of the present invention;

FIG. 2 is an assembly view of the present invention.

FIG. 3 is an application view of the present invention.

### DESCRIPTION OF THE PREFERRED EMBODIMENT

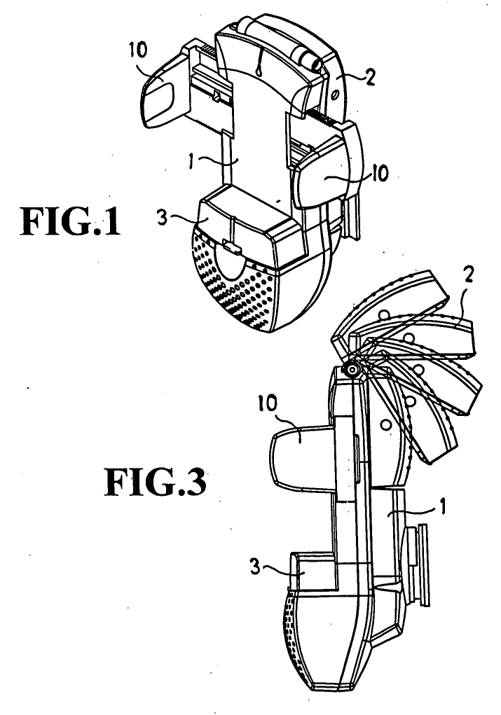

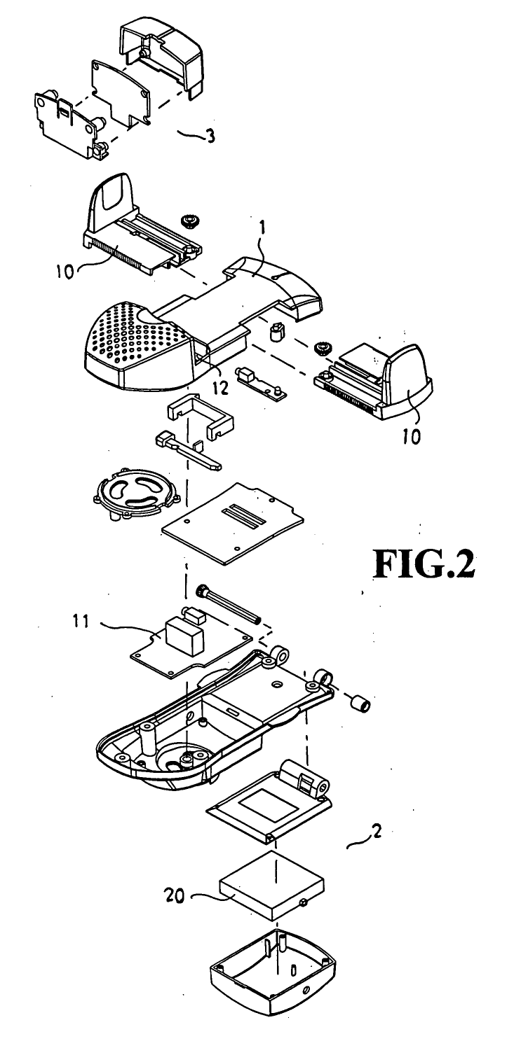

Referring to FIG. 1 to FIG. 3, the present invention comprises a base pedestal 1, a signal receiving pedestal 2 and a connecting pedestal 3. The function of each component is described as following:

The base pedestal 1 connects to car cigarette lighter through conducting points or plugs and form electrical connection; a pair of side clips 10 can fix mobile phones, PDA's, video games, LCD TV's onto the base pedestal 1; same as US listed pattern no. 5903645, a conversion circuitry 11 installed internally offers charging, power and hands-free function; an inserting slot 12 on the base pedestal 1 offers connecting pedestal 3 with different plug sets to plug in, for mobile phones, PDA's, video games, LCD TV's with corresponding connecting pedestals 3 with electrical connection. The revolvable receiving pedestal 2 is installed on one side of the base pedestal 1; in this application example, the receiving pedestal 2 is connected to the top of the base pedestal 1 with a hinge and revolves with definite angles; a signal receiver 20 is inside the receiving pedestal 2 and connects to the appliances attached with a conversion circuitry 11.

In real application, users plug in the base pedestal 1 into the arm rack connecting to the car cigarette lighter or the car cigarette lighter directly to be fixed, have power and electrical connection; when users want to have mobile phones, PDA's, video games, LCD TV's have power, are charged and have hands-free functions, users can have the corresponding connecting pedestal 3 connect these mobile appliances to the base pedestal 1, by the control and output of the conversion circuitry 11 inside the base pedestal 1, these mobile appliances can have power, be charged and have hands-free functions; at the same time, users can adjust the directions of receiving pedestal 2, base pedestal 1 or arm rack to have the receiving pedestal 2 aim the signal direction for the best transmission and satellite, video signals receiving effect, such scheme can lift the convenience of the appliances and signal receiving quality

While a preferred embodiment of the invention has been shown and described in detail, it will be readily understood and appreciated that numerous omissions, changes and additions may be made without departing from the spirit and scope of the invention.

1. An automobile appliance holder with signal receiver comprising:
a base pedestal connects to car cigarette lighter through conducting points or plugs and form electrical connection, a pair of side clips fix mobile phones, PDA's, video games, LCD TV's onto said base pedestal, a conversion circuitry installed internally offers charging, power and hands-free function, a connecting pedestal on said base pedestal for mobile appliances to insert and form electrical connection;
a revolvable receiving pedestal is installed on one side of said base pedestal, a signal receiver is inside said receiving pedestal and connects to the appliances attached with a conversion circuitry.

2. The automobile appliance holder with signal receiver recited in claim 1, wherein an inserting slot on said base pedestal offers said connecting pedestal with different plug sets to plug in, for mobile phones, PDA's, video games, LCD TV's with corresponding said connecting pedestals with electrical connection
